(19) United States
(12) Patent Application Publication
(10) Pub. No.: US 2026/0313456 A1
(43) Pub. Date: Oct. 8, 2026

(54) METHODS FOR CONTROLLING A PACKET DATA CONVERGENCE PROTOCOL COMMUNICATION NETWORK

(71) Applicant: CANON KABUSHIKI KAISHA, Tokyo (JP)

(72) Inventors: Yacine EL KOLLI, RENNES (FR); Pierre VISA, RENNES (FR); Pascal LAGRANGE, LA CHAPELLE DES FOUGERETZ (FR); Pascal ROUSSEAU, RENNES (FR)

(21) Appl. No.: 19/482,206

(22) PCT Filed: May 8, 2024
(86) PCT No.: PCT/EP2024/062833

§ 371 Date: Nov. 6, 2025

(30) Foreign Application Priority Data
May 9, 2023 (EP) 23315179.4
Jun. 26, 2023 (GB) 2309599.5
Jul. 21, 2023 (GB) 2311218.8

(51) Int. Cl. H04W 28/06; H04W 28/04; H04W 56/00

(52) U.S. Cl. CPC H04W 28/06; H04W 28/04; H04W 56/0015

(57) ABSTRACT

A method for controlling a packet data convergence protocol, PDCP, communication network, the communication network comprising user equipment (UE) and a base station, wherein the base station is configured to receive from, and/or send to, the UE at least one PDU Set The method at the base station comprises: receiving a transmission parameter associated with the at least one PDU Set; determining, based on the transmission parameter, at least one timing parameter according to which one or more performance indicators of the at least one PDU Set, and/or at least one PDU of the at least one PDU Set, are exchanged between the UE and the base station; and sending, to the UE, a performance indicator of the PDU Set based on the determined timing parameter.

### FIELD OF THE DISCLOSURE

The present disclosure generally relates to methods for controlling a Packet Data Convergence Protocol (PDCP) communication network. More particularly, the method relates to controlling one or more transceivers (e.g., a PCDP transmitter or receiver) of the communication network.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g., video, voice, messaging . . . etc.) over a radio access network (RAN) through one or more base stations.

Examples of wireless multiple-access communication systems include systems based on 3rd generation partnership project (3GPP-RTM) standards, such as fourth generation (4G) Long Term Evolution (LTE) or recent fifth generation (5G) New Radio (NR) systems, or systems based on IEEE 802.11 standards, such as Wi-Fi. Of these, 5G NR is configured with service requirements related to extended reality (XR) applications.

Several XR applications involve interactions between a wearable device (e.g., a 3D helmet or augmented reality glasses) and an application server. The wearable device and the application server can be connected through a local Network (e.g., a wireless LAN) or cellular network (e.g., a 3GPP 5G cellular network in which the application server is connected to a core part of the 5G core network). Some XR applications, such as cloud gaming, involve transferring compressed video data, and audio data from the server to the wearable device, and transferring position information from the wearable device to the server. Some XR applications, such as virtual reality, involve transferring compressed video data, audio data and various other information from the server to the wearable device. Some XR applications, such as augmented reality, involve transferring compressed video data, audio data and various information exchanged to and from the wearable device and the server.

XR applications generate data in the form of encoded video, audio and/or position information/data. This data is primarily arranged into data packets by the application. An application data packet representing one unit of information is generated at the application level. The application data packet may be referred to as a protocol data unit, or packet data unit (PDU). PDUs can be used to transport the application data in a PDU Set, which is composed of one or more PDUs carrying the payload of one unit of information generated at the application level (e.g., a frame or video slice for XRM Services, as used in TR 26.926).

Each PDU Set is characterised by identification information. For example, the identification information may define the start, stop, and/or length (e.g., the number of PDUs) of the PDU Set. However, at various points in the data transmission process, the receiving entity does not have knowledge of the PDU Set's identification information. Also, the network used to transport the application data can experience perturbation and congestion. It is therefore possible that some PDUs of a PDU Set are missing or are late at the receiving side.

Some video decoder applications require the reception of a complete application data packet (e.g., a complete PDU Set), received on time, to adequately decode a video. While other implementations can tolerate late arrival of data packets or partial delivery of data packets of a PDU Set. For example, these implementations rely on “Forward Error Correction” (FEC) technology or concealment techniques.

Accordingly, it is important to establish whether a PDU Set has been transmitted successfully. A known attempt to achieve this involves applying a “Quality of Service” (QoS) mechanism. In 3GPP document S2-2302696, it defines a PDU Set QoS parameter called PSDB (i.e., PDU Set Delay Budget) that defines a time budget allocated to the transport of the PDU Set across the 5G system. This QoS parameter defined by the application is used by a 5G system to assess if a PDU Set is delivered on time. An alternative QoS parameter is PSIHI (i.e., PDU Set Integrated Handling Indication) which is used to characterise the decoder's tolerance to loss or outdated data. For example, if the PSIHI parameter is set to “true”, then the decoder can only handle complete application data packets which are received on time. If the PSIHI is set to “false”, then the decoder can tolerate both incomplete and delayed application data packets. In some 3GPP documents, the PSIHI QoS parameter is also named PSII (i.e., PDU Set Integrated Indication).

In the 5G system, at a radio network part, when a PDU Set is being sent over the air interface, some information is available regarding the reception status of the PDUs and the elapsed time of the PSDB. For example, when a PDU Set is being transferred over the air, a RAN node (e.g., a UE or gNB) can detect that one PDU transmission has failed despite all the retransmissions and error correction mechanisms. In that case, if the PSIHI QoS parameter is set to “true”, it means the entire PDU Set is useless to the application. In that case if PDUs of this “useless” PDU Set are pending transmission over the air interface, then the RAN node can consider discarding the remaining transmission of these PDUs, thereby achieving radio network resource saving. In 3GPP document RP-223502, PDU Set discarding has been set as an objective for the enhancement of the Radio Access Network (RAN) in order to increase the 5G system capacity to handle XR applications.

A further known QoS parameter is the PDU Set Error Rate (PSER), which characterizes the application-level requirement for the reliability of the application data (as described in 3GPP document S2-2302696). In this way, PSER defines an upper bound for the rate of PDU Sets that have been processed by the sender of a link layer protocol (e.g., RLC in RAN of a 3GPP access) but that are not successfully delivered by the corresponding receiver to the upper layer (e.g., PDCP in RAN of a 3GPP access). For example, a PDU Set is considered as successfully delivered only when all PDUs of a PDU Set are delivered successfully. Alternatively, the PDU Sets which are discarded because of an elapsed delay budget (PSDB), are considered lost but they are not counted as a PDU Set error in the PSER calculation.

PSER QOS parameters are sent by the core network to the RAN nodes (e.g., UE, gNB) as part of the PDU session establishment procedure (as described in TS 23.502 clause 4.3.2). During operation, the RAN node (e.g., UE, gNB) needs to monitor the actual PDU Set error rate so that it can take corrective actions in case the measured rate does not match the required rate. For example, if the measured error rate is higher than the requirement (i.e., set by the PSER), then the gNB can take actions to change the RAN configuration to increase the transmission reliability. On the other hand, if the measured rate is lower than the PSER requirement, then the gNB may take actions to release some resources (e.g., by changing the RAN configuration towards being less reliable).

In downlink, the gNB is the transmitter (e.g., transmitting entity) of the PDU Set. In order to measure the PSER statistics, the gNB requires knowledge of the reception status of the PDU Sets. The PDU Set boundaries are not known at the UE side, so the UE can only report about PDUs reception status. The gNB may have knowledge of the PDU Set boundaries, but in order to determine the PDU Set error rate it requires PDU reception status information from the UE.

In uplink, the gNB is the receiver of the PDU Sets, but since it does not have knowledge of the PDU Set boundaries, it cannot measure the PSER from the received PDUs. Similarly, the UE has knowledge of the PDU Set boundaries, but it requires PDU reception status information from the gNB in order to determine the PSER statistics.

Known methods of exchanging PDU reception status information have limited use for determining PSER statistics in the PDCP protocol. PDCP reception status information is only transmitted from the receiving entity to the transmitting entity based on specific triggers related to UE mobility (see 3GPP document TS 38.323). By defining such a systematic trigger for the PDCP status reporting, this generates an unnecessary increase in the amount of additional data (overhead) transmitted across the PDCP layer.

PDU reception status information can be provided to the transmitting entity, for example, using the media access control (MAC) layer. Typically, the MAC layer is configured to implement a hybrid automatic repeat request (HARQ) mechanism, which when configured, provides reception status of MAC PDUs. However, MAC PDUs tend not be aligned on the boundaries of PDCP PDUs because of radio link control (RLC) segmentation. Alternatively, the RLC protocol layer provides reception status feedback when operating in an acknowledge mode (i.e., but not other operating modes). So, when the RLC layer operates in either an unacknowledged mode or a transparent mode (e.g., in order to achieve lower latency objectives), then reception status feedback is not provided. Accordingly, these methods provide poor reactivity when determining PSER statistics in the PDCP layer.

Accordingly, there is a need to provide a method to configure the reporting of PDCP reception status information and PSER statistics, when operating in both uplink and downlink, to achieve good reactivity while minimizing the induced overhead.

### SUMMARY

In accordance with a first aspect of the present disclosure, there is provided a method for controlling a packet data convergence protocol, PDCP, communication network, the communication network comprising user equipment, UE, (e.g., a first transceiver) and a base station (e.g., a second transceiver), wherein the base station is configured to receive from, and/or send to, the UE at least one PDU Set, the method at the base station comprising:
receiving a transmission parameter associated with the at least one PDU Set;
determining, based on the transmission parameter, at least one timing parameter according to which one or more performance indicators of the at least one PDU Set, and/or at least one PDU of the at least one PDU Set, are exchanged between the UE and the base station; and
sending, to the UE, a performance indicator of the PDU Set based on the determined timing parameter.

In accordance with a second aspect of the present disclosure, there is provided a method for controlling a packet data convergence protocol, PDCP, communication network, the communication network comprising user equipment, UE, (e.g., a second transceiver) and a base station (e.g., a first transceiver), wherein the base station is configured to receive from, and/or send to, the UE at least one PDU Set, the method at the base station comprising:
receiving a transmission parameter associated with the at least one PDU Set;
determining, based on the transmission parameter, at least one timing parameter according to which one or more performance indicators of the at least one PDU Set, and/or at least one PDU of the at least one PDU Set, are exchanged between the UE and the base station; and
receiving, from the UE, a performance indicator of the PDU Set based on the determined timing parameter.

In accordance with a third aspect of the present disclosure, there is provided a method for controlling a packet data convergence protocol, PDCP, communication network, the communication network comprising user equipment, UE, and a base station, wherein the UE is configured to send to, or receive from, the base station at least one PDU Set, the method at the UE comprising:
receiving a performance indicator of the PDU Set based on at least one timing parameter, wherein the at least one timing parameter is determined at the base station, based on a transmission parameter associated with the at least one PDU Set, the at least one timing parameter according to which one or more performance indicators of the at least one PDU Set, and/or at least one PDU of the at least one PDU Set, are exchanged between the base station and UE.

In accordance with a fourth aspect of the present disclosure, there is provided a method for controlling a packet data convergence protocol, PDCP, communication network, the communication network comprising user equipment, UE, and a base station, wherein the UE is configured to send to, or receive from, the base station at least one PDU Set, the method at the UE comprising:
sending a performance indicator of the PDU Set based on at least one timing parameter, wherein the at least one timing parameter is determined at the base station, based on a transmission parameter associated with the at least one PDU Set, the at least one timing parameter according to which one or more performance indicators of the at least one PDU Set, and/or at least one PDU of the at least one PDU Set, are exchanged between the base station and UE.

Each one of the above-described methods provide a means of identifying when one or more PDU Sets have been transmitted successfully. This reduces the need for error correction and concealment techniques and thereby reduces the post-transmission processing load on the PDCP communication network. Furthermore, the method provides a means of configuring a PDCP status reporting procedure which achieves increased reactivity to changes in the communication network. In contrast to known methods of PDCP status reporting methods (e.g., as defined in 3GPP document TS 38.323), the present method avoids the reliance on specific triggers related to the handover between different nodes of the communication network.

While the present method is described with reference to a first transceiver and a second transceiver (e.g., of the communication network), it will be appreciated that the method would apply to any suitable component of a communication network which comprised a transmitting means (e.g., a transmitter) and/or receiving means (e.g., a receiver).

The method at the base station or UE (e.g., first transceiver) may comprise sending the PDU Set (e.g., sending one or more PDUs of the PDU set). While the other of the base station and the UE (e.g., the second transceiver) may be configurable to receive the PDU Set. At least one of the PDUs of the PDU Set (e.g., the entire PDU set) may not be received by the second transceiver due to signal loss. Accordingly, in some situations the method may comprise receiving at least one PDU of the PDU Set, whereas in other situations the second transceiver may not receive any PDUs of the PDU Set. Advantageously, the second transceiver may still be configurable to send the performance indicator regardless of how many PDUs are received. For example, the performance indicator may be configured to indicate that at least some, all, or none of the PDUs of the PDU Set have been received.

At least one, or each, of the transmission parameter and performance indicator may be associated with a single PDU Set, and/or a plurality of PDU Sets (e.g., two or more subsequent PDU Sets). The timing parameter may be associated with at least one PDU (e.g., a plurality of PDUs) of a given PDU Set. The method may comprise determining a plurality of timing parameters. At least one of the plurality of timing parameters (e.g., a first timing parameter) may be used by the first transceiver. At least one of the plurality of timing parameters (e.g., a second timing parameter) may be used by the second transceiver.

The transmission parameter may comprise information indicative of the periodicity of the PDU Set. The transmission parameter may comprise information indicative of at least one of a PDU Set period, a PDU Set frequency, and a number of PDUs in the PDU Set. The periodicity of a PDU Set is the period between two successive PDU Sets. For example, the periodicity may be indicative of a time period measured between the start of a first PDU Set (e.g., the first PDU of the first PDU Set) and the start of a second (subsequent) PDU Set (e.g., the first PDU of the second PDU Set).

The method at the base station (e.g., second transceiver) may comprise receiving the transmission parameter from the UE (e.g., first transceiver).

The method at the base station (e.g., second transceiver) may comprise receiving the transmission parameter from a core network component of the communication network.

The transmission parameter may be configured in the form of time sensitive communication assistance information, TSCAI.

The timing parameter may comprise at least one of a PDCP status reporting rate, a PDCP status reporting period, a PSER statistics reporting rate, and a PSER statistics reporting period.

The PDCP reporting rate (or period) may be advantageously determined so that the induced overhead is minimized. For example, the following criteria can be applied:
increasing the number of PDU status reports to reduce the induced overhead, or
reducing the number of PDU status reports (e.g., during a single PDU Set period) in order to reduce transmission of redundant information.

The PSER reporting rate (or period) may be advantageously determined so that the induced overhead is minimised, and the reported value is meaningful, and the reporting rate allows for good reactivity. For example, the following criteria can be applied:
Less frequent PSER reports to reduce the induced overhead.
The value is only meaningful when starting from a minimum number of PDU Set statuses (e.g., performance indicators) that are taken into account for the PSER calculation.
If the first transceiver (e.g., the PDU transmitter) needs to take corrective actions because of a significant change in the PSER measurements, then the PSER measurement period must be lowered.

The method at the base station (e.g., second transceiver) may comprise sending the timing parameter to the UE (e.g., first transceiver).

The method may comprise determining a PSER statistic based on the performance indicator. According to the first and third aspects, the method at the UE may comprise receiving the performance indicator and determining the PSER statistic based on the received performance indicator.

According to the second and fourth aspects, the method at the base station may comprise receiving the performance indicator and determining the PSER statistic based on the received performance indicator.

The method (e.g., at the base station according to the second aspect) may comprise waiting for receipt of the performance indicator, based on the timing parameter, before determining the PSER statistic. For example, the timing of the sending of the performance indicator may be determined based on the timing parameter. Advantageously, this enables the first transceiver to detect the loss of a performance indicator (since it knows from the timing parameter when to expect receipt of the performance indicator). Thus, it can take into account the uncertainty of some PDU Set statuses in the PSER statistics calculation.

The method may comprise configuring the transmission (e.g., sending) of the PDU Set (and/or at least one PDU of the PDU Set), based on the PSER statistic. The method may comprise reporting the PSER statistic to a core network component of the communication network. In some embodiments, all PDUs in a PDU Set are needed by the application layer to use the corresponding unit of information. In other implementations, the application layer can still recover parts, or all, of the information unit when some PDUs are missing. For example, one PDU Set may comprise the data of one image or frame from a video stream. By configuring the second transceiver based on the PSER statistics, the present method enables the communication network to adapt to different requirements of the application layer.

The method may comprise, prior to receiving the performance indicator, sending a performance indicator request (i.e., to the element of the communication network configured to send the performance indicator). For example, according to the first and third aspects, the method at the UE and base station may comprise, respectively, sending and receiving a performance indicator request. According to the second and fourth aspects, the method at the UE and base station may comprise, respectively, receiving and sending a performance indicator request.

The method may comprise sending the performance indicator request substantially towards the beginning of the PDU Set (e.g., at the beginning of the PDU Set). The method may comprise, upon receipt of the performance indicator request, counting a PDU Set period of the PDU Set (e.g., which is indicative of the time it takes for the PDU Set to be transmitted). In situations where the PDU transmitting element (e.g., the UE according to the first/third aspect) is configured to multiplex different PDU Set flows sent by the communication network (e.g., the XR application), two or more PDUs which are received by the PDU receiving element (e.g., the base station according to the first/third aspect) may not belong to the same PDU Set. In this case, the transceivers can realign their respective counters for the performance indicator period based on the reception of the performance indicator request.

The performance indicator may be indicative of the status of at least one (or each) of the PDUs of the PDU Set, which are received by the second transceiver.

The performance indicator may be indicative of the status of the two or more PDU Sets, the method comprises sending the performance indicator after two or more PDU Set cycles have been completed.

The method at may comprise delaying sending (e.g., by the UE according to the first/third aspects) a first PDU of a subsequent PDU Set until the performance indicator of the first PDU Set has been received (i.e., sent by the base station). The method may comprise waiting for receipt of a first PDU of a subsequent PDU Set before sending the performance indicator of the first PDU Set. Put another way, the method may comprise only receiving (e.g., by the base station according to the first/third aspects) the first PDU of a subsequent PDU Set after the performance indicator of the first PDU Set has been sent (e.g., by the UE). In this way, if the first transceiver was in power saving mode between two PDU Sets being sent, the second transceiver can ensure not to activate the first transceiver inappropriately.

The transmission parameter may be indicative of a jitter range of the communication network, the method may comprise: determining a time period based on the jitter range; and only waiting until the end of the determined time period to receive the first PDU of the subsequent PDU Set. Advantageously, if a PDU is lost then the transceiver will not wait indefinitely.

In the case of a handover from the base station (e.g., second transceiver) to a further base station (e.g., a third transceiver), the transmission parameter may be sent to the further base station as part of the handover procedure.

The base station and UE (e.g., first and second transceivers) may be configured with a counter to count a PDU Set period. The method may comprise realigning the counters of at least one, or each, of the UE and base station based on a reference event. The reference event may comprise each of the base station and UE receiving at least one of a first PDU of the PDU Set; and a PDU Set report request. This advantageously leverages the counting drift between the transceivers caused by, for example, the difference in the quality of the timers used in the different devices.

In embodiments, the communication network may be configured to operate in an uplink mode. In this case, the first transceiver may be arranged (e.g., located) on a user equipment (UE) of the communication network (e.g., an XR device). The second transceiver may be arranged on a gNodeB (gNB) of the communication network.

In embodiments, the communication network may be configured to operate in a downlink mode. In this case, the first transceiver may be arranged on a gNodeB (gNB) of the communication network. The second transceiver may be arranged on a user equipment (UE).

In known methods of controlling communication networks during downlink conditions, the PDUs may be formatted by the core network PDU layer. Similarly, during uplink, the PDUs may be formatted by the UE PDU layer. In the case of 3GPP, the delimitations of the PDU Sets (e.g., start, stop, and/or length (e.g., the number of PDUs) of the PDU Set) are not provided by the application but generated by the transmitter of the data (e.g., either the core network or UE during downlink and uplink, respectively) through media transport protocol packet inspection (see, for example, the detailed procedure outlined in 3GPP document S2-2302696).

During uplink conditions, the PDU Set identification information may be calculated by the UE PDU layer. However, this information is not inserted in any header, so the PDU Set identification information is not provided “in-band”. Hence, the gNB side (i.e., the receiving side during uplink) does not have access to the PDU Set identification information. On the transmit side, all the layers below the SDAP layer (e.g., of the PDCP transmitting entity) do not have access to in-band PDU Set identification information. Some internal mechanisms can associate out-band PDU Set delimitation information to each PDU. For example, in the gNB, the GTP-U receiving entity can associate out-band PDU Set delimitation information to each PDU and pass them to the PDCP transmitting entity. Also, in the UE, the PDU layer can associate out-band PDU Set delimitation information to each PDU and pass them to the PDCP transmitting entity. In contrast the method of the present disclosure, none of the above known methods provide an “in-band” means of identifying when a complete PDU Set has been transmitted successfully.

During downlink, the PDU Set identification information calculated by the core network's User Plane Function (UPF) is inserted into a GPRS Tunnelling Protocol User Plane (GTP-U as used in TS 29.281) header. GTP-U is the protocol used by the UPF to transport data from the core network to the gNB. When GTP-U PDUs arrive at a gNB Service Data Adaptation layer (SDAP, as used in TS 37.324), the GTP-U header is removed and the PDU Set identification information is no longer provided in-band. Hence the UE side (i.e., the receiving side (e.g., second transceiver) during downlink) does not have access to the PDU Set identification information. Therefore, these known methods of controlling the communication network in a downlink condition fail to identify when a complete PDU Set has been transmitted successfully, unlike the method of the present disclosure.

According to embodiments of the present disclosure, the method (e.g., when applied to PSER measurement for XR services) may be configured such that the PSER can be advantageously used in RAN at a gNB for configuring and scheduling of downlink and uplink transmissions. This means that the current PSER for each QoS flow shall be measured, and it shall be available at the gNB. For PSER measurement of a QoS flow, two types of information may be used: the reception status of a plurality of PDUs related to the QoS flow, and the delimitation of one or more PDU sets among the plurality of PDUs.

In known methods of controlling a PDCP network, there is no ‘in-band” information provided for PDU set identification. Consequently, PDU set delimitation in downlink is only known by a gNB. Further, PDU set delimitation in uplink is only known by a UE. Therefore, in this situation, a gNB cannot measure the PSER for a QoS flow in uplink. Consequently, since the PDU Set identification information is not provided “in-band”, a gNB (e.g., the receiver during uplink) does not have access to the PDU Set identification information for uplink transmission of QoS flows. Furthermore, a gNB cannot measure the PSER for a QoS flow transmission during uplink (because only a UE can measure the PSER during uplink).

In embodiments, the result of the PSER measurement by a UE may be provided to the gNB to allow the PSER to be enforced at the network side.

In embodiments, the UE(s) may be configured to control measuring the PSER for uplink transmission of QOS flows. Accordingly, information related to uplink PSER measurement by a UE may be provided to the gNB.

In addition to PDU set delimitation, the PSER measurement for a QoS flow may require the reception status of the related PDUs. There are different ways for a UE to obtain reception status of transmitted PDUs, but none of the current available methods can guarantee that the PSER measurement will always be possible. For example, according to known methods, the PDU reception status can be estimated through:
a HARQ status report, but this feature may not always be configured (in addition, MAC PDUs tend to not be aligned on the boundaries of PDCP PDUs because of RLC segmentation);
an RLC status report, but this report may only be available with the RLC Acknowledged Mode (when the RLC layer operates in either Unacknowledged Mode or Transparent Mode (e.g., in order to achieve lower latency objectives), reception status feedback is not provided); and
a PDCP status report, but the triggering for such status report may only relate to mobility, recovery, and/or reconfiguration.

It can be observed for PSER measurement at a UE that the reception status reports which are currently available at MAC, RLC, and PDCP layers may not be sufficient.

In embodiments, the PSER measurement is preferably performed at the PDCP layer of the communication network. For example, the PDCP status report may be configured to provide the status of the application PDUs directly, since the PDCP status report is considered the best candidate for PSER transmission. In embodiments relating to PSER measurement at a UE, the gNB may provide a PDCP status report to the UE.

The enhancement of the PDCP status report may require adding a new trigger to increase the transmission rate of this report. However, the new triggering conditions shall be carefully defined. A PDCP status report cannot be sent systematically (e.g., after the reception of a PDU), as this would generate a huge overhead. Also, reporting multiple times during a PDU Set period is not useful since it is related to the same PDU Set.

The PDCP status report may be generated and/or transmitted periodically (e.g., with a period that is determined based on the video frame rate of the application, such as an XR application). The PDCP status report may also be generated and/or transmitted by the gNB upon the reception of a request message from the UE. For example, the UE performing PSER measurement may have a better knowledge of the appropriate time to receive a PDCP status report.

In yet further embodiments, a PDCP status report for uplink PSER measurement may be generated and/or transmitted at an appropriate rate to facilitate PSER measurement and to limit the induced overhead.

Concerning PSER measurement feedback, once the PSER is measured at a UE, feedback shall be provided to the gNB. As for the PDCP status report, the transmission rate of PSER measurement feedback shall be appropriately defined to be relevant (e.g., to enable increased reactivity if the gNB needs to take corrective actions), without increasing the overhead. For example, the following considerations may be taken into account:
a lower frequency of the report results in less induced overhead;
the PSER measurement is only relevant when the status of a minimum number of PDU Sets is taken into account for the PSER measurement; and
in case of significant change in PSER measurement, then the PSER measurement feedback period may be lowered.

Optionally, the network may configure a UE performing PSER measurement to provide feedback to the gNB at an appropriate rate.

In accordance with a fifth aspect of the present disclosure, there is provided a communication network which comprises a network element (e.g., a base station or UE) as recited in claim 23 of the accompanying claims.

In accordance with a sixth aspect of the present disclosure, there is provided a transceiver (e.g., embodied within a base station or UE of the communication network) which is configured to perform the methods of any one of the preceding paragraphs (e.g., as defined by any one of claims 1 to 22).

The transceiver may be configured for use in a packet data convergence protocol, PDCP, communication network comprising a transmitting means (e.g., a first transceiver). The transceiver (e.g., which may define a second transceiver of the communication network) may be configurable to receive a PDU Set from the transmitting means. The transceiver may comprise a receiving means (e.g., a receiver) for receiving a transmission parameter associated with the PDU Set; a determining means for determining, based on the received transmission parameter, a timing parameter according to which one or more performance indicators of the PDU Set are exchanged between the transmitting means and the transceiver (e.g., the first and second transceivers of the communication network); and a transmitting means (e.g., a transmitter) for sending, or receiving, to a receiver of the communication network (e.g., the first transceiver), a performance indicator of the PDU Set based on the timing parameter.

The features of any one of the first, second, third and fourth aspects may be embodied in any suitable components of a communication network (e.g., a transmitter and/or a receiver). For example, the transmitting and receiving means may be arranged at different locations within the communication network (e.g., to define respective transmitting and receiving network nodes), or they may be arranged in a single element of the network (e.g., to a define a single component of the network, such as a transceiver of a UE or gNB etc.).

In accordance with a seventh aspect of the present invention, there is provided a computer program as recited in claim 24 of the accompanying claims.

In accordance with a eighth aspect of the present invention, there is provided a computer-readable medium as recited in claim 25 of the accompanying claims.

The PDU Set may comprise one or more PDUs. At least one, or each, PDU may be configured to carry a payload of one unit of information generated at the application level (e.g., a frame or video slice for XRM Services, as used in TR 26.926). Each PDU Set may be characterised by identification information (e.g., which defines the parameters of the PDU Set). For example, the identification information may define the start, stop, and/or length (e.g., the number of PDUs) of the PDU Set. However, at various points in the data transmission process, the receiving entity does not have knowledge of the PDU Set's identification information. In embodiments, the PDU identification information is unknown at all protocol layers (e.g., including the PDCP layer).

The present disclosure relates to communication networks for applications relating to extended reality (XR). Such communication networks may comprise third generation partnership protocol (3GPP) and fifth generation (5G) new radio (NR).

XR applications may be defined (e.g., in 3GPP document RP-2200285) as one or more types of augmented, virtual, and mixed environments, where human-to-machine and human-to-human communications are performed with the assistance of handheld and wearable end user devices. Several use cases are defined in 3GPP document TR-26.928.

The information exchanged to and from the UE (e.g., a wearable device) and the server may be referred to as application data. For example, application data may comprise one or more images, video data, audio data, position information and various information.

Application data (e.g., such as video, audio or position information/data) may be transferred between UE (e.g., wearable device) and the server using media transport protocols including RTP (Real Time Protocol, RFC 3550), SRTP (Secured RTP, RFC 3711), HTTP (Hyper Text Transfer Protocol, RFC 2616-7540) or QUIC (RFC 8999, 9000, 9001 and 9002). Video encoding and decoding can be performed according to various formats including MPEG2, H.264, H.265, HEVC, etc.

Any feature in one aspect of the disclosure may be applied to other aspects of the disclosure, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the disclosure, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the disclosure will now be described, by way of example only, and with reference to the following drawings in which:

FIG. 1 is a schematic diagram illustrating a first example wireless communication system in which the present disclosure may be implemented according to one or more aspects of the disclosure;

FIG. 2 illustrates a block schematic diagram of an example configuration of a UE in which the present disclosure may be implemented according to one or more aspects of the disclosure;

FIG. 3 illustrates a block schematic diagram of an example configuration of a base station in which the present disclosure may be implemented according to one or more aspects of the disclosure;

FIG. 4 is a block schematic diagram illustrating the data plane protocol stack of a 5G NR systems as represented in FIG. 1;

FIG. 5 is a block schematic diagram of an example of a PDCP protocol layer (e.g., according to 3GPP document TS 38.323);

FIG. 6 is a schematic and simplified diagram of an example message flow illustrating the disclosure in uplink;

FIG. 7 is a schematic and simplified diagram of an example message flow illustrating the disclosure in downlink;

FIG. 8 is a schematic and simplified diagram of an example message flow illustrating an alternative arrangement of the disclosure in uplink;

FIG. 9 is a schematic and simplified diagram of an example message flow illustrating an alternative arrangement of the disclosure in downlink;

FIG. 10 is a flow chart illustrating an example method executed by a PDCP receiving entity of a gNB in uplink;

FIG. 11 is a flow chart illustrating an example method executed by a PDCP transmitting entity 503 of a UE in uplink;

FIG. 12 is a flow chart illustrating an example method executed by a PDCP transmitting entity 502 of a gNB in downlink;

FIG. 13 is a flow chart illustrating an example method executed by a PDCP receiving entity of a UE in downlink; and

FIG. 14 is a flow chart illustrating an example method executed by a component of a PDCP communication network according to an aspect of the disclosure.

### DETAILED DESCRIPTION

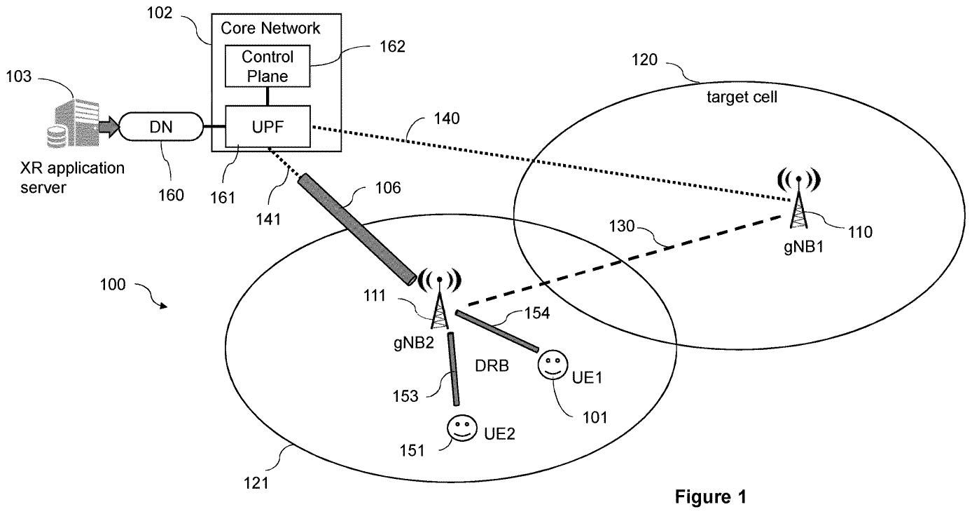

FIG. 1 illustrates an example wireless communication network (or system) 100, in particular a mobile radio communication system such as a fifth generation (5G) New Radio (NR) system supporting extended reality (XR) service. Although in the following description, embodiments and examples of embodiments of the present disclosure will be described with respect to a 5G NR system, it will be appreciated that it is not intended that the present disclosure is limited to 5G NR systems and may be used in any wireless communication systems supporting XR or similar service.

The system 100 comprises a user equipment (UE) 101, 151 which may be for instance virtual reality helmets or “extended reality” wearables such as glasses, served by a base station 110 to communicate with a core network, such as the 5G core network 102. UE 101 may be any wireless device, such as a wireless communication device or apparatus or terminal, IoT device, Machine Type Communication (MTC) device, Device to Device (D2D) terminal, user device (e.g. smart phone, laptop, mobile phone, tablet, camera, game console, wearable device), capable of wireless communication with one or more core networks via one or more Radio Access Networks. The base station 110 is a network node which provides an access point to the core network for a UE and is part of the Radio Access Network (RAN) composed of the base stations 110, and 111. In NR, base stations are referred to as next-generation Node Bs (gNBs), the RAN is a next generation (NG) RAN and the core network is referred to as the 5GC. In the following, the terms RAN node, base station and gNB will be used interchangeably. The base stations 110 and 111 are interconnected by means of the Xn interface (specified in the 3GPP document TS 38.423) implemented on the wired or wireless link 130. Each base station is connected to the core network 102 by means of the NG interface (specified in the 3GPP document TS 38.413) implemented on the wired or wireless links 140 and 141.

Each of these base stations 110, 111 controls one or multiple cells. For instance, the base station 110 controls the cell 120, and the base station 111 controls the cell 121. A cell is a geographical area of a radio network defined by the frequency used in the cell to transmit data. The cell can be uniquely identified by a UE 101 from an identification that is broadcasted over a geographical area. Each base station 110, 111 can serve several UEs, such as UE 101 or UE 151. Once a UE has established a radio resource control (RRC) connection with a base station 110, 111, the base station, to which UE 101, 151 is connected, is referred to as the serving base station (or source base station) of UE. The cell which is controlled by the serving base station, and on which UE camps, is referred to as the serving cell. The interface between a gNB and a UE is known as the Uu interface using the protocol sublayers SDAP (Service Data Adaptation Protocol), PDCP (Packet Data Convergence Protocol), RLC (Radio Link Control), MAC (Medium Access Control), PHY (Physical) in the user plane, and the protocol sublayers RRC (Radio Resource Control), PDCP, RLC, MAC, PHY in the control plane.

It is assumed that UE 101 is receiving and/or sending XR data of one or more multicast XR sessions generated and/or destinated to the XR application server 103. XR data is provided to the base station 111 (i.e., the base station controlling the cell 121 on which UE 101 is attached) through the core network 102 (i.e., through the Data Network 160 and the User Plane Function 161), link 141, and the transport bearer 106 (e.g., a GTP-U tunnel). Then, the XR data is transmitted by the base station 111 to UE 101 through the Data Radio Bearer (DRB) 154. FIG. 1 also shows UE 151 receiving data through DRB 153. A radio bearer is a set of PHY (layer 1) and MAC (layer 2) parameters allowing higher layer data connection between a UE and a gNB. Multiple types of radio bearers are defined in 5G NR: the SRB (Signalling Radio Bearer) for the control plane, the DRB (Data Radio Bearer) allowing point-to-point communication with one UE in the user plane (unicast), and the MRB allowing point-to-point communication and point-to-multipoint communication with multiple UEs (multicast/broadcast), also in the user plane.

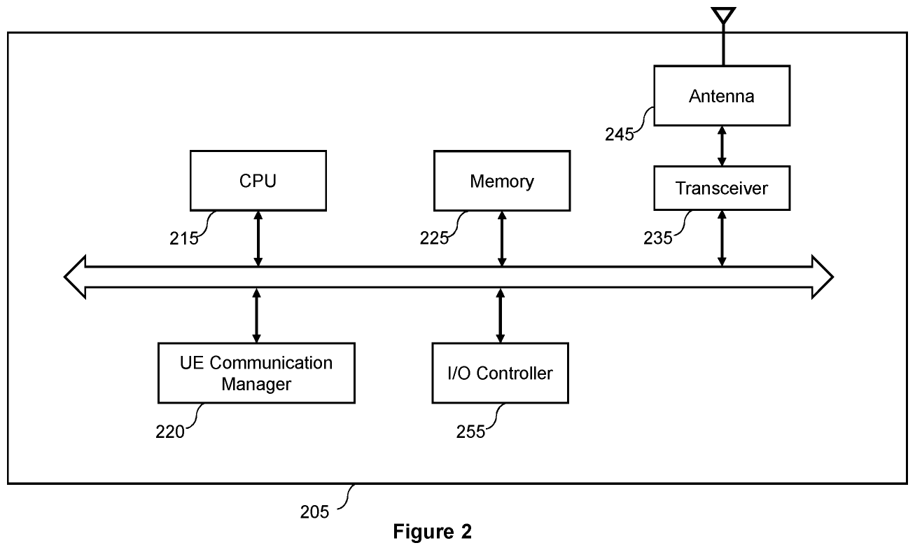

FIG. 2 illustrates a block diagram of a UE device 205, like UE 101 or UE 151 in the FIG. 1, in which the present disclosure may be implemented according to one or more embodiments of the disclosure. UE includes components for transmitting and receiving communications, for example including at least one of a UE communication manager 220, a I/O controller 255, a transceiver 235, a set of antennas 245, memory 225, and a processor (CPU: Central Processing Unit) 215. All these elements may communicate with each other.

Memory 225 includes RAM (Random Access Memory), ROM (Read Only Memory), or combination of both or as a non-limiting example a mass storage device such as a disk or a Solid-State Drive. Basic Input Output System (BIOS) Instructions may be stored within the memory 225.

The processor 215 is configured to execute machine readable instructions. Execution of these machine-readable instructions causes UE to perform various functions. These functions may be related to transmission or to interaction with peripheral devices like for instance a keyboard, a screen, a mouse, etc. (not shown in FIG. 2). The processor may run an operating system like for instance, iOS, Windows, Android, etc. The processor 215 may be a single processor or may comprise two or more processors carrying out the processing required for the operation of UE 205. The number of processors and the allocation of processing functions to the processors is a matter of design choice for a skilled person.

The I/O controller 255 allows these interactions with external peripherals by providing the hardware required and by managing input and output signals.

The I/O controller 255 may for example interact with all or part of an image capture device, an image rendering device, an audio capture device, an audio rendering device or a sensor device able to determine the use position.

The transceiver 235 is configured to provide bi-directional wireless communication with other wireless devices. For example, it provides the necessary modems and frequency shifters necessary to connect to one or more wireless networks, such as Wi-Fi, Bluetooth, LTE, 5G NR, etc. The transceiver 235 may comprise a PDCP transmitter and a PDCP receiver. The PDCP transmitter and the PDCP receiver may be implemented by the processor 215. The PDCP transmitter and the PDCP receiver may be a software only function implemented by the processor 215.

The radio communications use the antenna set 245 adapted to the spectrum of the frequency transposed signals, issued from the baseband modems. The antenna set 245 may be limited to one antenna, but preferably it contains several antennas, in order to provide beamforming capability.

UE communication manager 220 handles the communication establishment of UE to a Radio Access Network, its control and its release. UE regularly receives from the base station an indication of slots available for communication between UE and base station. UE then knows where in time and frequency it expects incoming data or must send its outgoing data, whether they belong to the control or data plane. In an example implementation, UE communication manager 220 implements the Uu interface.

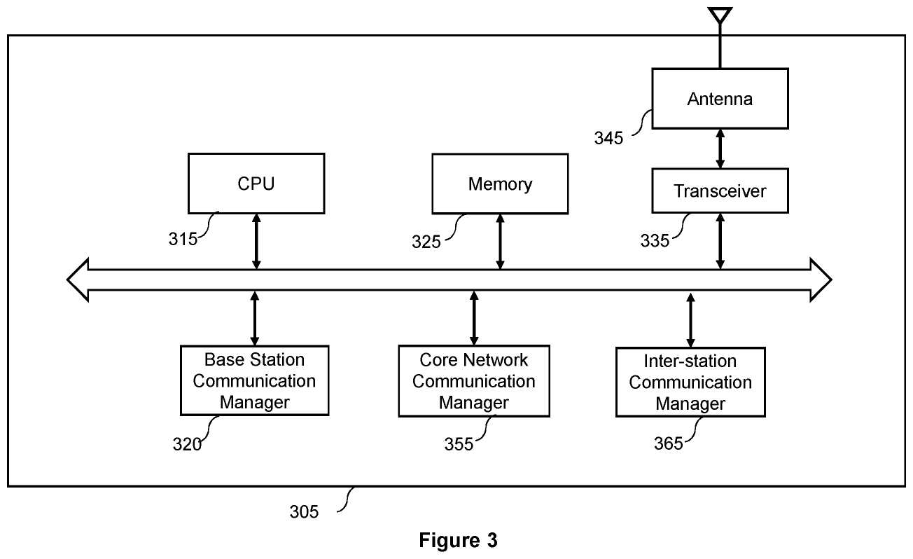

FIG. 3 illustrates a block diagram of a base station device 305, like the base stations or gNBs 110 and 111 in the FIG. 1, in which the present disclosure may be implemented according to one or more embodiments of the disclosure. The base station device 305 includes components for transmitting and receiving communications (i.e., a transmitter, receiver, or transceiver). For example, the base station includes at least one of a Base Station communication manager 320, a Core Network communication manager 355, a transceiver 335, a set of antennas 345, memory 325, a processor (CPU) 315, and an Inter-Station communication manager 365. All these elements may communicate with each other.

The Base Station communication manager 320 handles the communications with a plurality of UEs. It is responsible for the establishment, the control and the release of these communications. In an example implementation, the Base Station communication manager 320 implements the Uu interface. The Base Station communication manager 320 includes a scheduler that allocates time frequency slots to the different UE communications. Information regarding the schedule of these slots is regularly sent to the involved UEs. The Core Network communication manager (or transceiver) 355 manages communications of the base station with the core network. It may provide a standardized NG interface, as defined by the 3GPP standard, to support these communications.

The transceiver 335 is configured to provide bi-directional wireless communication with other wireless devices. These devices may be UEs, or even other base stations. The transceiver 335 provides the necessary modems and frequency shifters in order to connect to a large number of UEs simultaneously, using different frequency carriers, in Time Division Duplex (TDD) or in Frequency Division Duplex (FDD). The transceiver 335 may include a PDCP transmitter and a PDCP receiver. The PDCP transmitter and the PDCP receiver may be implemented by the processor 315. The PDCP transmitter and the PDCP receiver may be a software only function implemented by the processor 315. The transceiver 335 is connected to the antenna set 345, that may be limited to one antenna, but preferably it contains several antennas, in order to provide beamforming capability.

Memory 325 includes RAM, ROM, or combination of both or as a non-limiting example a mass storage device such as a disk or a Solid-State Drive. BIOS Instructions may be stored within the memory 325 to support an operating system.

The inter-station communication manager 365 manages communications with other base stations. The Inter-Station communication manager 365 may provide a standardized Xn interface, as defined by the 3GPP standard, to support these communications.

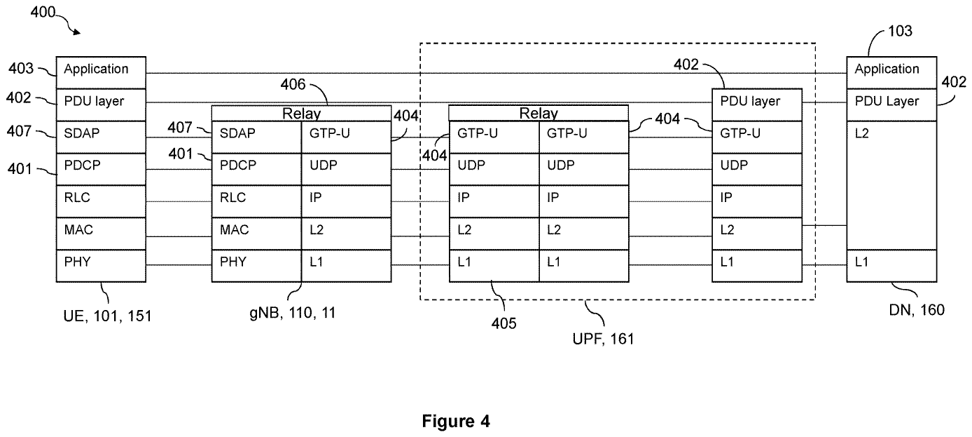

FIG. 4 is a block schematic diagram illustrating the data plane protocol stack of a 5G NR systems as represented in FIG. 1. This data plane protocol stack is described in detail in 3GPP document TS 23.501. In the downlink direction, an application server 103 connects to the UPF (User Plane Function) 161 through a data network 160 at PDU layer 402 level. PDU layer corresponds to the PDUs carried between UE (user Equipment) and the DN (Data Network) over the PDU Session. When the PDU Session Type is IPv4 or IPv6 or IPv4v6, it corresponds to IPv4 packets or IPv6 packets or both of them; and when the PDU Session Type is Ethernet, it corresponds to Ethernet frames; etc. At PDU session establishment time, the core network provides session QoS parameters to UPF, gNB and UE. The PDU session QoS parameters includes the XR PDU Set QoS parameters (S2-2302696):
PDU Set Delay Budget (PDSB).
PDU Set Error Rate (PSER).
PDU Set Integrated Handling Indication (PSIHI), formerly called PDU Set Integrated Indication.

In the description relating to FIG. 4, unless stated otherwise, a PDU refers to the packets handled by the PDU layer 402; all other layers handle other types of PDUs and their PDUs will be prefixed by the layer name, e.g., PDCP PDU. When the PDUs arrive at the UPF PDU layer 402, the UPF performs application packets inspection to determine the PDU Set boundaries. Document S2-2302696 provides examples on how to identify PDU Sets when inspecting RTP/SRTP header, RTP header extension, H.264 RTP payload, H.265 RTP payload and H.266 RTP payload.

PDU Set identification information as described in S2-2303842 are determined by UPF and sent to the NG-RAN in the GTP-U header. The PDU Set identification Information comprises:
PDU Set Sequence Number.
Indication of End PDU of the PDU Set
PDU Sequence Number within a PDU Set
PDU Set Size in bytes.
PDU Set Importance, which identifies the relative importance of a PDU Set compared to other PDU Sets within a QoS Flow.

In uplink the application is located on the UE. As explained earlier, the UE obtains the PDU session QOS parameter from the core network when the PDU session is established (PDU session establishment procedure is defined in TS 23.502 clause 4.3.2.). When the PDUs generated by the application 403 arrive at UE PDU layer 402, the UE performs an application packets inspection to determine the PDU Set boundaries in the same way as described earlier for UPF.

In both downlink and uplink, the application 103 sends and receives data to/from the NG-RAN through a GPRs tunnel (GTP-U layer 404, TS 29.281).

In downlink, the UPF detects the PDU Set identification information and obtains from the core network a set of mapping rules (e.g., filtering rules). The filtering rules define how each PDU Set is mapped to QoS flows. QoS Flows are identified by an identifier, and GTP-U PDUs are marked according to the determined QoS flow identifier. At the gNB, the relay layer 406 extracts PDU Set identification information and QoS flow identifier from GTP-U PDUs and maps them into SDAP QOS flows. In one XR session, multiple PDU Sets can be mapped to the same QoS flow. Alternatively (or in addition), one or more PDU Sets may be mapped to different QOS flows. Then according to 3GPP document TR- 38.835, in one alternative, each SDAP QOS flow can be mapped to a different PDCP DRB (Data Radio Bearer). According to a second alternative, all SDAP QOS flows from the same XR session are mapped to a single PDCP DRB.

In uplink, the UE detects the PDU Set identification information at PDU layer 402, and obtains from the core network a set of mapping rules (e.g., filtering rules). The filtering rules define how each PDU Set is mapped to QOS flows. The UE maps the XR PDUs to associated SDAP QOS flows according to the filtering rules. In the same way as for downlink, in uplink, in one XR session, multiple PDU Sets can be mapped to the same QoS flow and, in one XR session, some PDU Sets may be mapped to different QOS flows.

In downlink, the application layer 103, generates application flows toward one UE, for example one or more video flows and one or more audio flows. Then at PDU layer 402, the application flows are arranged in PDU Sets. Each application flow is divided into multiple PDU Sets of the same or different types. Then in GTP-U layer 404, each PDU Set type is mapped on QoS flows, so multiple application flows can be multiplexed in one QoS flow, or each application flows can be mapped to different QoS, it is also possible that an application flow is divided into multiple QOS flows. Then the SDAP layer 407 maps the QoS flows into DRBs (Data Radio Bearers) each DRB being handled by a dedicated PDCP entity. As with the QoS flows, multiple application flows can be multiplexed in one DRB, or each application flow can be mapped to a different DRBs. It is also possible that an application flow is divided into multiple DRBs.

In uplink, the application layer 403, generates applications flows toward the application server 103, for example one or more video flows, one or more audio flows, one or more sensing flow. Then at PDU layer 402, the application flows are arranged in PDU Sets. Each application flow is divided in multiple PDU Sets of same or different types and each PDU Set type is mapped on QOS flows, so multiple application flows can be multiplexed in one QoS flow, or each application flows can be mapped to different QoS. It is also possible that an application flow is divided into multiple QoS flows. Then the SDAP layer 407 maps the QoS flows into DRBs (Data Radio Bearer) each radio bearer being handled by a dedicated PDCP entity. Same as for QOS flows, multiple application flows can be multiplexed in one DRB, or each application flows can be mapped to DRBs, it is also possible that an application flow is divided into multiple DRBs.

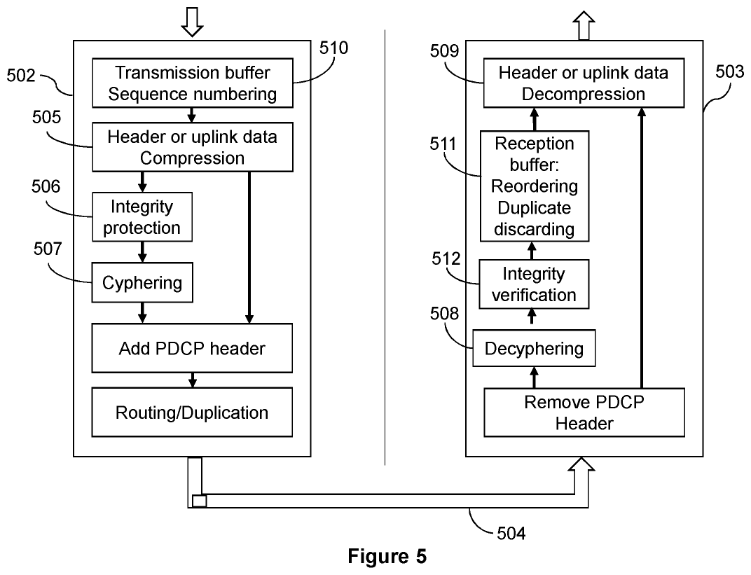

FIG. 5 is a block schematic diagram of an example of a PDCP protocol layer according to 3GPP document TS 38.323. A PDCP layer 401 is composed of a PDCP transmitting entity 502 and a PDCP receiving entity 503 (e.g., a first transceiver and a second transceiver). In this figure, the two PDCP entities do not belong to the same NG-RAN node. The two PDCP entities are connected by radio communication 504 which represents a simplified view on all lower layers from RLC to PHY. For example, PDCP transmitting entity 502 is located on UE 101 and PDCP receiving entity 503 is located on gNB 111. However, the present disclosure is not limited to this particular example, the PDCP transmitting entity (PDCP transmitter) 502 may be located on the gNB 111 and the PDCP receiving entity (PDCP receiver) 503 may be located on UE 101. Each NG-RAN node implements both PDCP transmitting and receiving entities, they are not all represented in this figure for simplicity.

Each functional block of the PDCP entities is described in detail in 3GPP document TS 38.323. Each PDCP entity is carrying the data of one radio bearer. A PDCP entity is associated either to the control plane or the user plane depending on which radio bearer it is carrying data for. A PDCP entity associated with DRB/MRB can be configured by RRC layer (TS 38.331, control plane not shown in FIG. 4) to use header compression or uplink data compression (UDC) 505. Robust header compression protocol (ROHC), the Ethernet header compression protocol (EHC) and UDC are supported. Each header compression protocol is independently configured for a DRB/MRB. The compression 505 is performed by the transmitting entity 502, and the decompression 509 is performed by the receiving entity 503.

The integrity protection function includes both integrity protection 506 and integrity verification 512 and is performed in PDCP, if configured by RRC. The data unit that is integrity protected is the PDCP PDU header and the data part of the PDCP PDU before ciphering. The integrity protection is always applied to PDCP Data PDUs of SRBs (Signalling Radio Bearer). The integrity protection is not applicable to PDCP Control PDUs.

The ciphering function includes both ciphering 507 and deciphering 508 and is performed in PDCP, if configured. The data unit that is ciphered is the MAC-I (1203, 1213, 1223) and the data part of the PDCP Data PDU except the SDAP header and the SDAP Control PDU if included in the PDCP SDU (Service Data Unit). The ciphering is not applicable to PDCP Control PDUs.

If configured, PDCP transmitting entity 502 performs buffer sequence numbering 510, while PDCP receiving entity 503 performs re-ordering and duplication discarding 511.

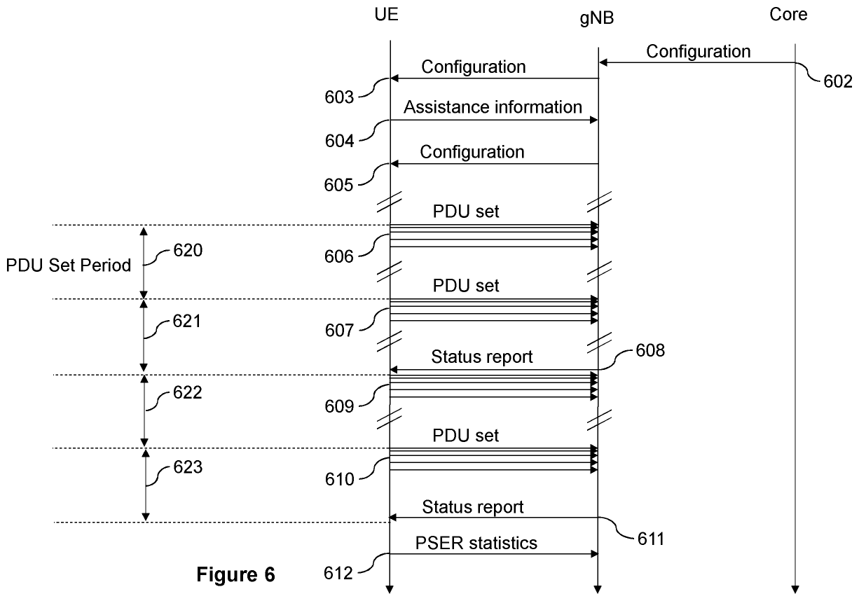

FIG. 6 is a schematic and simplified diagram of an example message flow illustrating the disclosure in uplink. It shows a sequence of PDCP PDUs exchanged between a PDCP transmitting entity 502 (e.g., UE 101) and a PDCP receiving entity 503 (e.g., gNB 111).

At first, as part of the PDU session establishment procedure (TS 23.502 clause 4.3.2.), the core network sends the QoS parameters including the PSER (PDU Set Error Rate), PSDB (PDU Set Delay Budget) and PSIHI (PDU Set Integrated Handling Indication) to the gNB in message 602 and the gNB forwards at least QoS parameters to UE in message 603. For example, message 602 is a N2 PDU Session Request message and message 603 is an N1/NAS PDU Session Establishment accept message, or a PDU Session Modification Command message.

Once the PDU session is established, the UE sends assistance message 604 to the gNB including a PDU Set periodicity parameter (i.e., a transmission parameter). For example, the message 604 is a MAC CE message (TS 38.321, clause 6.1.3), or a PDCP control message (TS 38.323, clause 6.1.2), or a UEAssistanceInformation message or a RRCReconfigurationComplete message or a RRCSetupComplete message (All in TS 38.331, clause 6.2.2). The assistance message 604 includes for each DRB at least:
DRB identifier: identification of PDCP entity, for example DRB-identity as defined in TS 38.331, clause 6.3.2
Period list: list of PDU Set periodicities. As described in FIG. 4, PDU Sets of different application flows can be multiplexed in one DRB. PDU Set periodicity is linked to the application flow periodicity, it can equal or a multiple of the application flow period, depending on the mapping of the application flow to QoS flow and to DRBs.
PDU Set size list: list of average PDU Set size in number of PDCP PDUs, (as described in FIG. 4, PDU Sets of different application flows can be multiplexed in one DRB).

In an alternative arrangement, the assistance message 604 is sent by the core network to the gNB. In this case, the assistance message 604 can be a TSCAI (Time Sensitive Communication Assistance Information).

In case of UE mobility, if UE is handed over to a target gNB, then the assistance message 604 is sent a second time from the UE or from the core network or from the source gNB to the target gNB as part of the handover procedure.

For each DRB (each PDCP entity), the gNB calculates a PDCP Status reporting rate, and PSER reporting rate, taking into account at least, the traffic periodicity of the PDU Sets multiplexed in the DRB as indicated in the assistance message 604. In case PDU Sets of different periodicities are multiplexed in the DRB, the gNB can consider a multiple of the smallest period or select the longest period as a reference. The PDCP status reporting period is advantageously determined so that the induced overhead is minimized. For example, the following criteria can be applied:
More received PDUs statuses is reported the less is the induced overhead,
Reporting multiple times during a PDU Set period is not useful since it is related to the same PDU Set.

The PSER reporting rate is advantageously determined so that the induced overhead is minimised, and the reported value is meaningful, and the reporting rate allows for good reactivity. For example, the following criteria can be applied:
Less frequent is the report the less is the induced overhead.
The value is only meaningful starting from a minimum number of PDU Sets status taken into account for PSER calculation. The number of PDU Set is equivalent to a number of periods.
If the gNB needs to take corrective actions because of a significant change in PSER measurements, then the PSER measurement period must be lowered.

In configuration message 605, the gNB sends the PDCP status reporting period and the PSER reporting period to the UE. The gNB will send a PDCP status report following the configured status report period and will be expecting a PSER statistics report from UE at the configured PSER reporting period. The configuration message 605, can for example be implemented as a RRCReconfiguration message, or RRCSetup message (both defined in TS 38.331, clause 6.2.2). In this example, the gNB determined that it will send a PDCP status report 608, at every two PDU Set cycles. Also, in this example the gNB will configure UE to send the PSER statistics at every four PDU Set cycles.

After assistance and configuration messages, the UE starts sending PDU Sets 606, 607 composed of several PDCP PDUs following the PDU Set period.

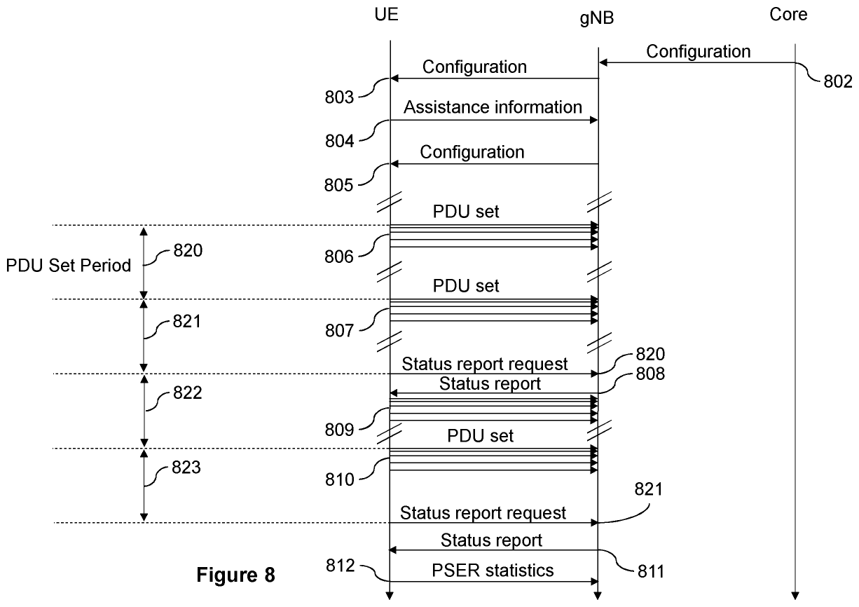

At the end of PDU Set period 621, the gNB sends a first PDCP status report 608 containing the status of all PDUs of the two PDU Sets 606 and 607. Advantageously, the gNB starts counting the PDU Set period after receiving the first PDU of the PDU Set 606. However, in some cases UE will multiplex different flows sent by the same PDCP transmitting entity (different flows multiplexed in one DRB), so the first PDU received by the gNB might not belong to a PDU Set, and in this case, in an alternative arrangement the UE might send a PDCP status report request message (820, further described in FIG. 8) at the beginning of the PDU Set period, then the gNB can start counting the PDU Set period from the reception of the PDCP Status Report Request message.

Advantageously, the gNB will not send the PDCP status report right at the end of the PDU Set period 621 but the gNB will rather wait for the reception of the first PDU of the following PDU Set 609 before sending the PDCP Status report 608. In that way, if the UE was in power saving mode between two PDU Sets sending, the gNB is insured not to wake up the UE inappropriately between two PDU Sets sending.

After receiving the first PDCP status report 608, the UE updates the PSER statistics. Still following the PDU Set period (or frequency), the UE sends two more PDU Sets 609 and 610.

At the end of PDU Set period 623, the gNB sends a second PDCP status report 611 containing the status of all PDUs of the two PDU Sets 609 and 610.

After receiving the second PDCP status report 611, the UE updates the PSER statistics. Since four PDU Set periods elapsed (620-623), the UE sends the PSER statistics to the gNB in message 612. Message 612 can be implemented as:
a PDCP control PDU (TS 38.323, clause 6.1.2),
a MeasurementReport message,
a MeasurementReportAppLayer (both in TS 38.331, clause 6.2.2), or
a MAC CE (TS 38.321, clause 6.1.3).

Advantageously, the UE should wait for the reception of PDCP Status report 611 to update the PSER statistics before sending the PSER statistics message 612. This is possible thanks to the configuration message 605 indicating both PSER statistic report and PDCP status report periodicity. Since it knows the PDCP status report period, the UE can advantageously detect the loss of a PDCP status report, thus it can take into account the uncertainty of some PDU Set status in the PSER statistics calculation. In case of detected PDCP status report loss, the UE in an alternative arrangement can send a PDCP Status Request message (For example 821 in FIG. 8).

For all embodiments, the gNB and UE may be configured to count PDU Sets period using timers or counters. During the time of the session a drift can happen between the counting of UE and the gNB for example due to clock quality difference between the two devices. To leverage the counting drift each device may realign their counter on some reference events like the reception of the first PDU of a PDU Set or the reception of a PDU Set report request message. Alternatively, the gNB and UE local clocks can be synchronized using IIOT clock synchronization mechanism described in TS 38.300 clause 16.8.

For all embodiments, the PDU Sets can be delivered to the transmitting entity (e.g., the first transceiver) by the application with some jitter. Advantageously the expected jitter range is notified to either UE and the gNB by the application from either the core network or UE. For example, if the gNB waits for the reception of the first PDU of the following PDU Set 609 before sending the PDCP Status report 608, then it shall not wait indefinitely but rather wait for an amount of time representative of the expected jitter range. Also, for example, UE will take into account the jitter range when wating for the next PDCP status report.

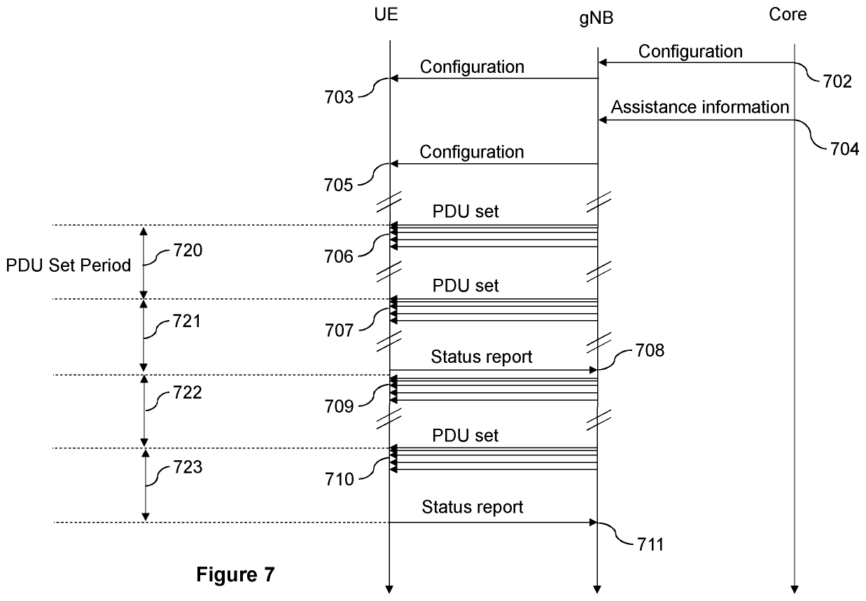

FIG. 7 is a schematic and simplified diagram of an example message flow illustrating the disclosure in downlink. It shows a sequence of PDCP PDUs exchanged between a PDCP transmitting entity 502 (for example gNB 111) and a PDCP receiving entity 503 (for example UE 101).

At first, as part of the PDU session establishment procedure (TS 23.502 clause 4.3.2.), the core network sends the QoS parameters including the PSER, PSDB and PSIHI to the gNB in message 702. The gNB forwards at least QoS parameters to the UE in message 703. For example, message 702 is a N2 PDU Session Request message and message 703 is a N1/NAS PDU Session Establishment accept message, or a PDU Session Modification Command message.

Once the PDU session is established, the core network sends message 704 to the gNB. Message 704 can be a TSCAI (Time Sensitive Communication Assistance Information) including PDU Set periodicity parameter. The message 704 includes for each DRB at least:
DRB identifier: identification of PDCP entity, for example DRB-identity as defined in TS 38.331, clause 6.3.2
Period list: list of PDU Set periodicities. As described in FIG. 4, PDU Sets of different application flows can be multiplexed in one DRB. PDU Set periodicity is linked to the application flow periodicity, it can equal or a multiple of the application flow period, depending on the mapping of the application flow to QoS flow and to DRBs.
PDU Set size list: list of average PDU Set size in number of PDCP PDUs (As described in FIG. 4, PDU Sets of different application flows can be multiplexed in one DRB).

In an alternative arrangement the message 704 is sent by the UE to the gNB. In that case the message 704 is:
a MAC CE message (TS 38.321, clause 6.1.3),
a PDCP control message (TS 38.323, clause 6.1.2),
a UEAssistanceInformation message,
a RRCReconfigurationComplete message, or
a RRCSetupComplete message (All in TS 38.331, clause 6.2.2).

In case of UE mobility, if the UE is handed over to a target gNB, then message 704 is sent a second time from the UE or from the core network or from the source gNB to the target gNB as part of the handover procedure.

For each DRB (each PDCP entity), the gNB calculates a PDCP Status reporting rate, taking into account at least, the traffic periodicity of the PDU Sets multiplexed in the DRB as indicated in message 704. In case PDU Sets of different periodicities are multiplexed in the DRB, the gNB can consider a multiple of the smallest period or select the longest period as a reference. The reporting status period is advantageously determined so that the induced overhead is minimized. For example, the following criteria can be applied:
More received PDUs statuses is reported the less is the induced overhead.
Reporting multiple times during a PDU Set period is not useful since it is related to the same PDU Set.

In configuration message 705, the gNB sends the PDCP status reporting period. The gNB will be expecting the UE to send a PDCP status report following the configured status report period. The configuration message 705, can for example be implemented as a RRCReconfiguration message, or RRCSetup message (both defined in TS 38.331, clause 6.2.2). In this example, the gNB determined that the UE shall send a PDCP status report 708, at every two PDU Set cycles.

After assistance and configuration messages, the gNB starts sending PDU Sets 706, 707 composed of several PDCP PDUs following the PDU Set period.

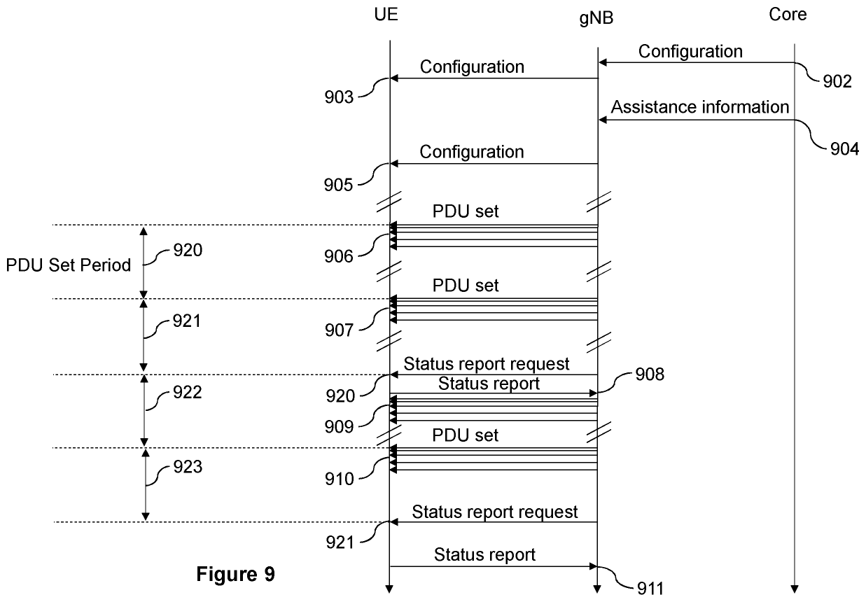

At the end of PDU Set period 721, UE sends a first PDCP status report 708 containing the status of all PDUs of the two PDU Sets 706 and 707. Advantageously, the UE starts counting the PDU Set period after receiving the first PDU of the PDU Set 706. However, in some cases the gNB will multiplex different flows sent by the same PDCP transmitting entity (different flows multiplexed in one DRB), so the first PDU received by UE might not belong to a PDU Set, and in this case, in an alternative arrangement the gNB might send a PDCP status report request message (920, in FIG. 9) at the beginning of the PDU Set period, then the UE can start counting the PDU Set period from the reception of the PDCP Status Report Request message.

After receiving the first PDCP status report 708, the gNB updates the PSER statistics. Still following the PDU Set period (or frequency), the gNB sends two more PDU Sets 709 and 710. At the end of PDU Set period 723, UE sends a second PDCP status report 711 containing the status of all PDUs of the two PDU Sets 709 and 710. After receiving the second PDCP status report 711, the gNB updates the PSER statistics.

Since it knows the PDCP status report period, the gNB can advantageously detect the loss of a PDCP status report, thus it can take into account the uncertainty of some PDU Set status in the PSER statistics calculation. In case of detected PDCP status report loss, the gNB in an alternative arrangement can send a PDCP Status Request message (Not shown in this figure).

FIG. 8 is a schematic and simplified diagram of an example message flow illustrating an alternative arrangement of the disclosure in uplink. It shows a sequence of PDCP PDUs exchanged between a PDCP transmitting entity 502 (e.g., UE 101) and a PDCP receiving entity 503 (e.g., gNB 111).

At first, as part of the PDU session establishment procedure (TS 23.502 clause 4.3.2.), the core network sends the QoS parameters including the PSER, PSDB and PSIHI to the gNB in message 802. The gNB forwards at least the QoS parameters to the UE in message 803. For example, message 802 is a N2 PDU Session Request message and message 803 is a N1/NAS PDU Session Establishment accept message, or a PDU Session Modification Command message.

Once the PDU session is established, the UE sends message 804 to the gNB. The message 804 includes a PDU Set periodicity parameter. For example, the message 804 is:
a MAC CE message (TS 38.321, clause 6.1.3),
a PDCP control message (TS 38.323, clause 6.1.2),
a UEAssistanceInformation message,
a RRCReconfigurationComplete message, or
a RRCSetupComplete message (All in TS 38.331, clause 6.2.2).

The message 804 includes for each DRB at least:
a DRB identifier: identification of PDCP entity, for example DRB-identity as defined in TS 38.331, clause 6.3.2,
a period list: list of PDU Set periodicities. As described in FIG. 4, PDU Sets of different application flows can be multiplexed in one DRB. PDU Set periodicity is linked to the application flow periodicity, it can equal or a multiple of the application flow period, depending on the mapping of the application flow to QoS flow and to DRBs,
PDU Set size list: list of average PDU Set size in number of PDCP PDUs (As described in FIG. 4, PDU Sets of different application flows can be multiplexed in one DRB).

In an alternative arrangement the message 804 is sent by the core network to the gNB. In this case message 804 can be a TSCAI (Time Sensitive Communication Assistance Information).

In case of UE mobility, if the UE is handed over to a target gNB, then message 804 is sent a second time from UE or from the core network or from the source gNB to the target gNB as part of the handover procedure.

For each DRB (each PDCP entity), the gNB calculates a PDCP Status reporting rate, and PSER reporting rate, taking into account at least the traffic periodicity of the PDU Sets multiplexed in the DRB as indicated in message 804. In case PDU Sets of different periodicities are multiplexed in the DRB, the gNB can consider a multiple of the smallest period or select the longest period as a reference. The reporting status period is advantageously determined so that the induced overhead is minimized. For example, the following criteria can be applied:
more received PDUs statuses is reported the less is the induced overhead;
reporting multiple times during a PDU Set period is not useful since it is related to the same PDU Set.

The PSER reporting rate is advantageously determined so that the induced overhead is minimised, and the reported value is meaningful, and the reporting rate allows for good reactivity. For example, the following criteria can be applied:
less frequent is the report the less is the induced overhead;
the value is only meaning full starting from a minimum number of PDU Sets status taken into account for PSER calculation. The number of PDU Set is equivalent to a number of periods;
if gNB needs to take corrective actions because of a significant change in PSER measurements, then the PSER measurement period must be lowered.

In configuration message 805, the gNB sends the PDCP status reporting period and the PSER reporting period to UE. The gNB will expect a PDCP status report request from the UE following the configured status report period and will be expecting a PSER reporting from the UE at the configured PSER reporting period. The configuration message 805, can for example be implemented as a RRCReconfiguration message, or RRCSetup message (both defined in TS 38.331, clause 6.2.2). In this example, the gNB determines that the UE will send a PDCP status report request 820, at every two PDU Set cycles. Also, in this example the gNB will configure the UE to send PSER statistics at every four PDU Set cycles.

After assistance and configuration messages have been sent, the UE starts sending PDU Sets 608 composed of several PDCP PDUs following the PDU Set period.

At the end of PDU Set period 821, the UE sends a first PDCP status report request message 820 (e.g., a first performance indicator request), then the gNB sends a PDCP status report 808 containing the status of all PDUs of the two PDU Sets 806 and 807.

Advantageously, the UE will send the PDCP status report request right after the end of a sleep period so that, if the UE was in power saving mode between two PDU Sets sending, the gNB is insured not to wake up the UE inappropriately between two PDU Sets sending.

After receiving the first PDCP status report 808, the UE updates the PSER statistics. Still following the PDU Set period (or frequency), the UE sends two more PDU Sets 809 and 810. At the end of PDU Set period 823, the UE sends a second PDCP status request message 821, then the gNB sends a second PDCP status report 811 containing the status of all PDUs of the two PDU Sets 809 and 810. After receiving the second PDCP status report 811, the UE updates the PSER statistics.

Since four PDU Set periods elapsed (820-823), UE sends the PSER statistics to the gNB in message 812. Message 812 can be implemented as:
a PDCP control PDU (TS 38.323, clause 6.1.2),
a MeasurementReport message,
a MeasurementReportAppLayer (both in TS 38.331, clause 6.2.2), or
a MAC CE (TS 38.321, clause 6.1.3).

Advantageously, the UE should wait for the reception of PDCP Status report 811 to update the PSER statistics before sending the PSER statistics message 812. This is possible thanks to the configuration message 805 indicating both PSER statistic report and PDCP status report periodicity. In case of detected PDCP status report loss (no status report received after status report request), UE may send another PDCP Status Request message.

FIG. 9 is a schematic and simplified diagram of an example message flow illustrating an alternative arrangement of the disclosure in downlink. It shows a sequence of PDCP PDUs exchanged between a PDCP transmitting entity 502 (for example gNB 111) and a PDCP receiving entity 503 (for example UE 101).

At first, as part of the PDU session establishment procedure (TS 23.502 clause 4.3.2.), the core network sends the QoS parameters including the PSER (PDU Set Error Rate), PSDB (PDU Set Delay Budget) and PSIHI (PDU Set Integrated Handling Indication) to the gNB in message 902 and the gNB forwards at least QoS parameters to UE in message 903. For example, message 902 is a N2 PDU Session Request message and message 903 is a N1/NAS PDU Session Establishment accept message, or a PDU Session Modification Command message.

Once the PDU session is established, the core network sends message 904 to the gNB. Message 904 can be a TSCAI (Time Sensitive Communication Assistance Information) including PDU Set periodicity parameter. The message 904 includes for each DRB at least:
a DRB identifier: identification of PDCP entity, for example DRB-identity as defined in TS 38.331, clause 6.3.2,
a period list: list of PDU Set periodicities. As described in FIG. 4, PDU Sets of different application flows can be multiplexed in one DRB. PDU Set periodicity is linked to the application flow periodicity, it can equal or a multiple of the application flow period, depending on the mapping of the application flow to QoS flow and to DRBs,
PDU Set size list: list of average PDU Set size in number of PDCP PDUs (As described in FIG. 4, PDU Sets of different application flows can be multiplexed in one DRB)

In an alternative arrangement the message 904 is sent by the UE to the gNB. In that case the message 904 is:
a MAC CE message (TS 38.321, clause 6.1.3),
a PDCP control message (TS 38.323, clause 6.1.2),
a UEAssistanceInformation message or a RRCReconfigurationComplete message, or
a RRCSetupComplete message (All in TS 38.331, clause 6.2.2).

In case of UE mobility, if the UE is handed over to a target gNB, then message 904 is sent a second time from UE or from the core network or from the source gNB to the target gNB as part of the handover procedure.

For each DRB (each PDCP entity), the gNB calculates a PDCP Status reporting rate, taking into account at least, the traffic periodicity of the PDU Sets multiplexed in the DRB as indicated in message 904. In case PDU Sets of different periodicities are multiplexed in the DRB, the gNB can consider a multiple of the smallest period or select the longest period as a reference.

The reporting status period is advantageously determined so that the induced overhead is minimized. For example, the following criteria can be applied:
more received PDUs statuses are reported the less is the induced overhead,
reporting multiple times during a PDU Set period is not useful since it is related to the same PDU Set.

In configuration message 905, the gNB sends the PDCP status reporting period. The gNB will be sending to UE a PDCP status report request following the configured status report period and the gNB will be expecting UE to send a corresponding PDCP Status report. The configuration message 905, can for example be implemented as a RRCReconfiguration message, or a RRCSetup message (both defined in TS 38.331, clause 6.2.2). In this example, the gNB determined that the UE shall send a PDCP status report 908, at every two PDU Set cycles in response to a PDCP status report request sent by the gNB.

After the assistance and configuration messages have been sent (e.g., exchanged), the gNB starts sending PDU Sets 906, 907 composed of several PDCP PDUs following the PDU Set period.

At the end of the PDU Set period 921, the gNB sends a first PDCP status report request 920 to the UE, then the UE sends a PDCP status report 908 containing the status of all PDUs of the two PDU Sets 906 and 907. After receiving the first PDCP status report 908, the gNB updates the PSER statistics. Still following the PDU Set period (or frequency), the gNB sends two more PDU Sets 909 and 910. At the end of PDU Set period 923, the gNB sends a second PDCP status report request 921 to the UE, then the UE sends a second PDCP status report 911 containing the status of all PDUs of the two PDU Sets 909 and 910. After receiving the second PDCP status report 911, the gNB updates the PSER statistics. In case of detected PDCP status report loss (no status report received after status report request), the gNB may send another PDCP Status Request message.

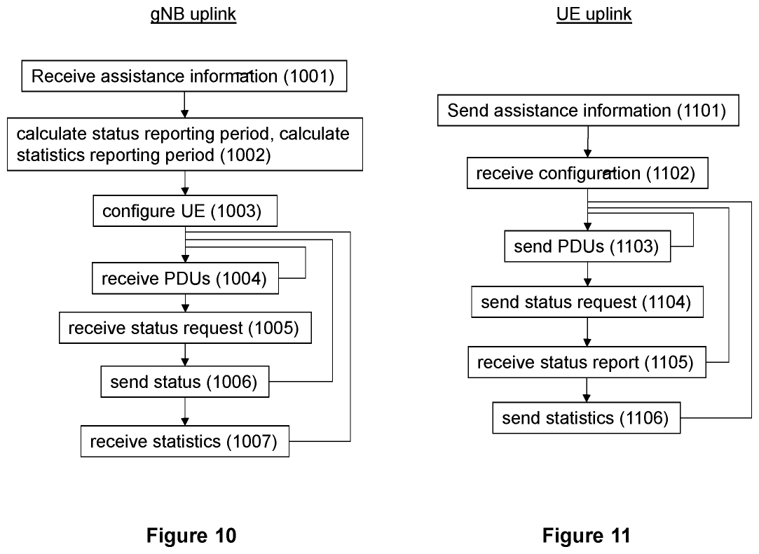

FIG. 10 is a flow chart illustrating an example method executed by a PDCP receiving entity 502 of a gNB (e.g., the second transceiver) in uplink according to an arrangement of the disclosure.

During step 1001, the gNB receives an assistance message 604, 804. The assistance message includes a PDU Set periodicity parameter (e.g., a transmission parameter).

Then during step 1002, the gNB calculates a PDCP Status reporting rate, and PSER reporting rate (e.g., timing parameters), taking into account at least, the periodicity parameter of the PDU Sets multiplexed in the DRB as received in step 1001.

In cases where PDU Sets with different periodicities are multiplexed in the DRB, the gNB can consider a multiple of the smallest period or select the longest period as a reference. The reporting status period is advantageously determined so that the induced overhead is minimized. For example, the following criteria can be applied:
more received PDUs statuses is reported the less is the induced overhead,
reporting multiple times during a PDU Set period is not useful since it is related to the same PDU Set.

The PSER reporting rate is advantageously determined so that the induced overhead is minimised and the reported value is meaningful and the reporting rate allows for good reactivity. For example, the following criteria can be applied:
the lower the frequency of the report, the less is the induced overhead,
the value is only meaningful if starting from a minimum number of PDU Set's statuses taken into account for the PSER calculation,
the number of PDU Sets is equivalent to a number of periods, or
if the gNB needs to take corrective actions because of a significant change in PSER measurements, then the PSER measurement period must be lowered.

During step 1003, the gNB sends a configuration message 605, 805 to the UE (e.g., the first transceiver) containing the PDCP status reporting period and the PSER reporting period (e.g., the timing parameters).

At step 1004, the gNB receives PDUs from the UE. Step 1004 is repeated as long as PDUs keep arriving from the UE.

At optional step 1005 the gNB receives a PDCP status report request message 820, 821 (e.g., performance indicator request) sent by the UE following the period configured in step 1003. Step 1006 either follows optional step 1005 or is triggered from step 1004 after the period of status reporting calculated in step 1002 has elapsed. During this step the gNB sends a PDCP status report 608, 611, 808, 811 (e.g., performance indicator) to the UE.

Advantageously the gNB starts counting the period of PDCP status reporting after receiving the first PDU during step 1004. However, in some cases the UE will multiplex different flows sent by the same PDCP transmitting entity (different flows multiplexed in one DRB), so the first PDU received by the gNB might not belong to a PDU Set, and in this case, in an alternative arrangement the UE might send a PDCP status report request message 820 (e.g., performance indicator request) at the beginning of the PDU Set period, then the gNB can realign the counter for status report period from the reception of the PDCP Status Report Request message.

After step 1006, step 1004 is repeated until the statistics reporting period is reached. In that case step 1007 is executed for the reception of the PSER statistics from the UE. The gNB can use these statistics to adapt the radio resources allocation or change the UE configuration or reflect the statistics to the core network. After step 1007, step 1004 is repeated. At any time, step 1001 can be triggered if updated assistance information is received. Also, step 1002 can be triggered at any time by the gNB to adjust the reporting and statistic periods.

FIG. 11 is a flow chart illustrating an example method executed by a PDCP transmitting entity 503 of a UE (e.g., first transceiver) in uplink according to an arrangement of the disclosure.

During step 1101, the UE sends an assistance message 604, 804 including a PDU Set periodicity parameter (e.g., transmission parameter).

During step 1102, the UE receives a configuration message 605, 805 from the gNB (e.g., second transceiver) containing the PDCP status reporting period and the PSER reporting period (e.g., timing parameters).

At step 1103, the UE sends PDUs to the gNB. Step 1103 is repeated at each time a new PDU Set is ready to be sent (following the PDU Set period, as sent in the assistance message during step 1001).

At optional step 1104, the UE sends a PDCP status request message 820, 821 (e.g., performance indicator request) to the gNB following the status report period received in step 1102.

Step 1105 either follows optional step 1104 or is triggered by the reception of a PDCP Report status (e.g., performance indicator) sent by the gNB 608, 611, 808, 811. At step 1105, the UE updates the PSER statistics.

After step 1105, step 1103 is repeated until statistic reporting period is reached. In that case step 1106 is executed for sending the PSER statistics to the gNB. After step 1106, step 1103 is repeated. At any time step 1001 can be triggered if updated assistance information needs to be sent. Also, step 1002 can be triggered at any time by the reception of updated configuration.

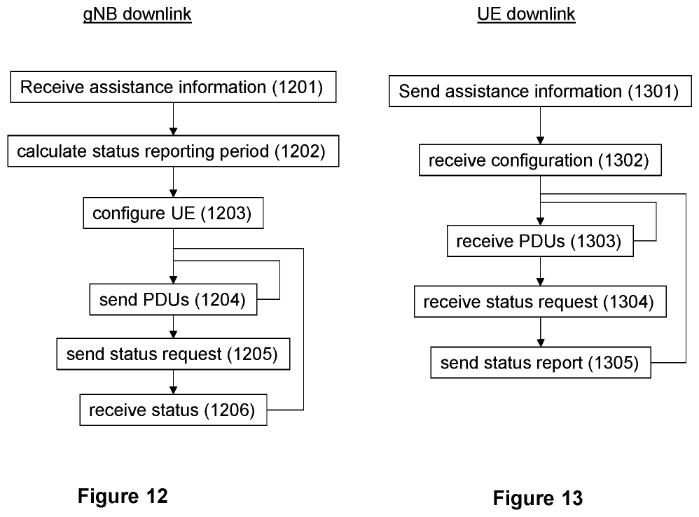

FIG. 12 is a flow chart illustrating an example method executed by a PDCP transmitting entity 502 of a gNB (e.g., first transceiver) in downlink according to an arrangement of the disclosure.

During step 1201, the gNB receives an assistance message 704 or 904. The assistance message includes a PDU Set periodicity parameter (e.g., transmission parameter).

Then, during step 1202 the gNB calculates a PDCP Status reporting rate, and PSER reporting rate, taking into account at least, the periodicity parameter of the PDU Sets multiplexed in the DRB as received in step 1201.

During step 1203, the gNB sends a configuration message 705, 905 to the UE (e.g., second transceiver) containing the PDCP status reporting period and the PSER reporting period (e.g., timing parameters).

At step 1204, the gNB sends PDUs to the UE. Step 1204 is repeated at each time a new PDU Set is ready to be sent (following the PDU Set period, as received in the assistance message during step 1201).

At optional step 1205, the gNB sends a PDCP status request message 920, 921 (e.g., performance indicator request) to the UE following the period configured in step 1203.

Step 1206 either follows optional step 1205 or is triggered from step 1204 by the reception of a PDCP status report (e.g., performance indicator). During this step the gNB receives a PDCP status report 708, 711, 908, 911 from the UE.

During step 1206 the gNB updates the PSER statistics. The gNB can use these statistics to adapt the radio resources allocation or change the UE configuration or reflect the statistics to the core network. After step 1206, step 1204 is repeated.

At any time step 1201 can be triggered if updated assistance information is received. Also, step 1202 can be triggered at any time by gNB to adjust the reporting and statistic periods.

FIG. 13 is a flow chart illustrating an example method executed by a PDCP receiving entity 503 (e.g., second transceiver) of a UE in downlink according to an arrangement of the disclosure.

During step 1301, the UE sends an assistance message 704 or 904 including PDU Set periodicity parameter (e.g., transmission parameter).

During step 1302, the UE receives a configuration message 705, 905 to the UE containing the PDCP status reporting period and the PSER reporting period (e.g., timing parameters).

At step 1203, the UE receives PDUs from the gNB (e.g., first transceiver). Step 1203 is repeated as long as PDUs keep arriving from gNB.

At optional step 1204, the UE receives a PDCP status request message 920, 921 (e.g., performance indicator request) from the gNB.

Step 1305 either follows optional step 1304 or is triggered from step 1303 after the period of status reporting received in step 1302 has elapsed. During this step UE sends a PDCP status report 708, 711, 908, 911 (e.g., performance indicator) to the gNB. After step 1305, step 1303 is repeated.

At any time, step 1301 can be triggered if updated assistance information needs to be sent. Also, step 1302 can be triggered at any time by the reception of updated configuration.

In embodiments in which a PDCP status report is requested (e.g., the PDCP status report requests described with reference to FIGS. 8 to 13). The PDCP status report request may include an identification of PDUs to report (e.g., specific PDUs of a given PDU Set). In such cases, the PDCP status report is configured to contain the status of the PDUs which are identified in the received PDCP status report request. Accordingly, the element which sends the PDCP status report request (e.g., the UE in FIG. 8) may be configured to only request the status report information corresponding to some of the PDUs in a given PDU Set, which advantageously reduces the transmission load on the network (i.e., by reducing the amount of information contained within the resulting PDCP status report).

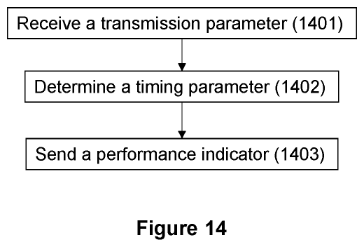

FIG. 14 is a flow chart illustrating an example method executed by one or more components of a communication network according to the present disclosure. The communication network comprising a first transceiver (502) and a second transceiver (503). The second transceiver is configured to receive a PDU Set from the first transceiver. The method at the second transceiver comprises a first step 1401 of receiving a transmission parameter associated with the PDU Set. A second step 1402 comprises determining a timing parameter based on the received transmission parameter. The timing parameter is indicative of when performance indicators of the PDU Set are to be exchanged between the first and second transceivers. The method proceeds with a third step 1403, in which the second transceiver sends, based on the timing parameter, a performance indicator of the PDU Set to the first transceiver.

According to embodiments of the present disclosure, the method (e.g., when applied to PSER measurement for XR services) may be configured such that the PSER can be advantageously used in RAN at a gNB for configuring and scheduling of downlink and uplink transmissions. This means that the current PSER for each QoS flow shall be measured, and it shall be available at the gNB.

For PSER measurement of a QoS flow, two types of information are needed: the reception status of PDUs related to this QoS flow, and the delimitation of PDU set among these different PDUs.

It is considered that no ‘in-band” information is provided for PDU set identification, it means that in the current situation, PDU set delimitation in downlink is only known by a gNB, and PDU set delimitation in uplink is only known by a UE. Therefore, in the current situation, a gNB cannot measure the PSER for a QoS flow in uplink.

Thus, it can be observed that as the PDU Set identification information is not provided “in-band”, a gNB (i.e., the receiver for uplink) does not have access to the PDU Set identification information for uplink transmission of QoS flows. Furthermore, a gNB cannot measure the PSER for a QoS flow transmission in uplink.

The consequence of these observations is that only a UE will be able to measure a PSER in uplink. As the PSER should be enforced at the network side, the result of this PSER measurement by a UE shall be provided to the gNB.

Furthermore, it is proposed that UEs may be in charge of measuring the PSER for uplink transmission of QoS flows, and that information related to uplink PSER measurement by a UE shall be provided to the gNB.

As previously mentioned, in addition to PDU set delimitation, the PSER measurement for a QOS flow requires the reception status of the related PDUs. There are different ways for a UE to obtain reception status of transmitted PDUs, but none of the current available methods can guarantee that the PSER measurement will always be possible. Indeed, PDUs reception status can be estimated through:
a HARQ status report, but this feature may not always be configured. In addition, MAC PDUs tend to not be aligned on the boundaries of PDCP PDUs because of RLC segmentation;
an RLC status report, but this report is only available with the RLC Acknowledged Mode. When the RLC layer operates in either Unacknowledged Mode or Transparent Mode (e.g., in order to achieve lower latency objectives), reception status feedback is not provided;
a PDCP status report, but the triggering for such status report is only related to mobility, recovery, or reconfiguration.

Further, it can be observed that for PSER measurement at a UE, the reception status reports which are currently available at MAC, RLC, and PDCP layers may not be sufficient.

To provide enhancement to a reception status report, the PDCP status report is the best candidate. Indeed, PSER measurement is preferably performed at the PDCP layer, and the PDCP status report could directly provide the status of the application PDUs.

Yet further, it is proposed that for PSER measurement at a UE, the gNB may provide PDCP status reports to the UE.

The enhancement of the PDCP status report may require adding a new trigger to increase the transmission rate of this report. However, the new triggering conditions shall be carefully defined. A PDCP status report cannot be sent systematically (i.e., after the reception of a PDU), as this would generate a huge overhead. Also, reporting multiple times during a PDU Set period is not useful since it is related to the same PDU Set.

The PDCP status report may be generated and sent periodically with a period that may depend on the video frame rate of the application. The PDCP status report may also be generated and sent by the gNB upon the reception of a request message from the UE. Indeed, the UE performing PSER measurement has a better knowledge of the appropriate time to receive a PDCP status report.

Still further, it is proposed that a PDCP status report for uplink PSER measurement may be generated and transmitted at an appropriate rate to facilitate PSER measurement and to limit the induced overhead.

Concerning PSER measurement feedback, once the PSER is measured at a UE, feedback shall be provided to the gNB. As for the PDCP status report, the transmission rate of PSER measurement feedback shall be appropriately defined to be relevant (i.e., to allow a good reactivity if the gNB needs to take corrective actions), without introducing a large overhead. For example, the following considerations may be taken into account:
a lower frequency of the report results in less induced overhead;
the PSER measurement is only relevant when the status of a minimum number of PDU Sets is taken into account for the PSER measurement;
in case of significant change in PSER measurement, then the PSER measurement feedback period may be lowered.

Moreover, it is proposed that the network may configure a UE performing PSER measurement to provide feedback to the gNB at an appropriate rate.

The embodiments described above, related to PSER measurement and feedback for uplink transmission, fulfil the need for uplink PSER measurement performed at UEs, and for enhancements to trigger PDCP status report allowing a relevant PSER measurement with a limited overhead.

Although the embodiments of the present disclosure have been described in relation to PDCP PDUs (and PDU Sets), the present disclosure is not limited to this type of PDU. The methods of the present disclosure can be applied to the transmission and reception of any sequenced PDUs, in particular, the present disclosure is applicable to in-sequence PDU transmission on any layer.

While the present disclosure has been described with reference to examples and embodiments, it is to be understood that the disclosure is not limited to the disclosed examples and embodiments. It will be appreciated by those skilled in the art that various changes and modification might be made without departing from the scope of the disclosure, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments (i.e., exemplary arrangements), the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fibre optic cable, twisted pair, digital subscriber line (DSL), or wireless technologies such as infrared, radio, and microwave, then the coaxial cable, fibre optic cable, twisted pair, DSL, or wireless technologies such as infrared, radio, and microwave may be included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for controlling a packet data convergence protocol, PDCP, communication network, the communication network comprising user equipment, UE, and a base station, wherein the base station is configured to receive from, and/or send to, the UE at least one packet data unit, PDU, Set, the method at the base station comprising:
receiving a transmission parameter associated with the at least one PDU Set;
determining, based on the transmission parameter, at least one timing parameter according to which one or more performance indicators of the at least one PDU Set, and/or at least one PDU of the at least one PDU Set, are exchanged between the UE and the base station; and
sending, to the UE, a performance indicator of the PDU Set based on the determined timing parameter.

2. A method for controlling a packet data convergence protocol, PDCP, communication network, the communication network comprising user equipment, UE, and a base station, wherein the base station is configured to receive from, and/or send to, the UE at least one packet data unit, PDU, Set, the method at the base station comprising:
receiving a transmission parameter associated with the at least one PDU Set;
determining, based on the transmission parameter, at least one timing parameter according to which one or more performance indicators of the at least one PDU Set, and/or at least one PDU of the at least one PDU Set, are exchanged between the UE and the base station; and
receiving, from the UE, a performance indicator of the PDU Set based on the determined timing parameter.

3. A method according to claim 1, wherein the transmission parameter comprises information indicative of the periodicity of the PDU Set.

4. A method according to claim 1, wherein the transmission parameter comprises information indicative of at least one of a PDU Set period, a PDU Set frequency, and a number of PDUs in the PDU Set.

5. A method according to claim 1, wherein the method comprises receiving the transmission parameter from the UE.

6. A method according to-any claim 1, wherein the method comprises receiving the transmission parameter from a core network component of the communication network.

7. A method according to claim 6, wherein the transmission parameter is configured in the form of time sensitive communication assistance information, TSCAI.

8. A method according to claim 1, wherein the at least one timing parameter comprises at least one of a PDCP status reporting rate, a PDCP status reporting period, a PSER statistics reporting rate, and a PSER statistics reporting period.

9. A method according to claim 1, wherein the method comprises at least one of:
sending the at least one timing parameter to the UE;
determining a PSER statistic based on the performance indicator;
configuring transmission of the PDU Set, or at least one PDU of the PDU Set, based on the PSER statistic; and
reporting the PSER statistic to a core network component of the communication network.

10. (canceled)

11. A method according to claim 9, wherein determination of the PSER statistic is delayed, based on the timing parameter, until receipt of the performance indicator.

12. (canceled)

13. A method according claim 1, wherein the method comprises sending the performance indicator in dependence on a performance indicator request.

14. A method according to claim 13, wherein transmission of the performance indicator request occurs substantially towards the beginning of the PDU Set. or wherein the method comprises, upon sending or receiving the performance indicator request, counting a PDU Set period of the PDU Set.

15. (canceled)

16. A method according claim 1, wherein the performance indicator is indicative of the status of at least one of the plurality of PDUs in the PDU Set or the status of two or more PDU Sets, and wherein, the method comprises sending or receiving the performance indicator after two or more PDU Set cycles have been completed.

17. (canceled)

18. A method according to claim 1, wherein the method comprises:
delaying sending a first PDU of a subsequent PDU Set until the performance indicator of the first PDU Set has been received, or
only receiving the first PDU of a subsequent PDU Set after the performance indicator of the first PDU Set has been sent.

19. A method according to claim 18, wherein the transmission parameter is indicative of a jitter range of the communication network, the method comprising:
determining a time period based on the jitter range; and
only waiting until the end of the determined time period to receive the first PDU of the subsequent PDU Set.

20. A method according to claim 1, wherein in the case of a handover from the base station to a further base station, the transmission parameter is sent to the further base station as part of the handover procedure.

21. A method according claim 1, wherein the UE and base station comprise a counter configured to count a PDU Set period, the method comprises realigning the counters of the UE and base station based on a reference event which comprises each of the UE and base station receiving at least one of a first PDU of the PDU Set, and a PDU Set report request.

22. A method for controlling a packet data convergence protocol, PDCP, communication network, the communication network comprising user equipment, UE, and a base station, wherein the UE is configured to send to, or receive from, the base station at least one packet data unit, PDU Set, the method at the UE comprising:
receiving, or sending, a performance indicator of the PDU Set based on at least one timing parameter, wherein the at least one timing parameter is determined at the base station, based on a transmission parameter associated with the at least one PDU Set, wherein the at least one timing parameter is determined according to which one or more performance indicators of the at least one PDU Set, and/or at least one PDU of the at least one PDU Set, are exchanged between the base station and UE.

23. A communication network which comprises:
a base station configured to perform the method of claim 1.

24. A non-transitory computer-readable medium carrying instructions which, when executed by a base station, causes the base station to carry out the method according to claim 1.

25. A non-transitory computer-readable medium carrying instructions which, when executed by a UE, causes the UE to carry out the method according to claim 22.
